(19) United States
(12) Patent Application Publication
(10) Pub. No.: US 2024/0288608 A1
(43) Pub. Date: Aug. 29, 2024

(54) ATYPICAL METASURFACE, WAVEGUIDE IMAGE COMBINER AND AUGMENTED REALITY DEVICE USING ATYPICAL METASURFACE

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Jeonggeun YUN, Suwon-si (KR); Byoungho LEE, Seoul (KR); Chulsoo CHOI, Seoul (KR); Kyookeun LEE, Suwon-si (KR); Taewon CHOI, Seoul (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 18/654,937

(22) Filed: May 3, 2024

Related U.S. Application Data
(63) Continuation of application No. PCT/KR2022/017063, filed on Nov. 2, 2022.

(30) Foreign Application Priority Data
Nov. 3, 2021 (KR) 10-2021-0150030

(51) Int. Cl. G02B 1/00; G02B 27/01

(52) U.S. Cl. CPC G02B 1/002; G02B 27/0172; G02B 2027/0132

(57) ABSTRACT

An atypical metasurface, includes: a 2-dimensional plane; and a plurality of atypical unit structures periodically arranged on the 2-dimensional plane, wherein each of the plurality of atypical unit structures has an atypical pattern that is not periodic.

### CROSS-REFERENCE TO RELATED APPLICATIONS

This application is a continuation of International Application No. PCT/KR2022/017063, filed on Nov. 2, 2022, which is based on and claims priority to Korean Patent Application No. 10-2021-0150030, filed on Nov. 3, 2021, in the Korean Intellectual Property Office, the disclosures of which are incorporated by reference herein in their entireties.

### BACKGROUND

### 1. Field

The present disclosure relates to an atypical metasurface, a method of designing the same, and a waveguide image combiner and an augmented reality device using the atypical metasurface.

### 2. Description of the Related Art

An augmented reality (AR) device enables a user to view AR, and includes, for example, AR glasses. An image optical system of the AR device includes an image generation device that generates an image and a waveguide that transmits the generated image to the eyes of a user. Such an AR device is required to have a wide field of view and a high-quality image, and is required to be lightweight and compact.

Recently, optical systems based on waveguides have been researched and developed as AR devices, such as AR glasses. Waveguides in related technologies use free-form surface reflection or multi-mirror reflection or use diffractive coupling devices such as diffractive optical devices or holographic optical devices, so as to input or expand/output light.

### SUMMARY

Additional aspects will be set forth in part in the description which follows and, in part, will be apparent from the description, or may be learned by practice of the presented embodiments.

According to an aspect of the disclosure, provided is an atypical metasurface, a method of designing the same, a waveguide image combiner using the atypical metasurface, and an augmented reality device.

According to an aspect of the disclosure, the atypical metasurface may increase the diffractive efficiency of a specific order, such that the waveguide image combiner employing the atypical metasurface may transmit a bright virtual image at low power, and thus, the size and thickness of the waveguide image combiner may be reduced, whereby an augmented reality (AR) device may improve the brightness of an image to be displayed and may have a compact size, and power consumption required for the display engine may be reduced.

According to an aspect of the disclosure, the atypical metasurface may have a high diffractive efficiency at a wide viewing angle, such that the waveguide image combiner and the AR device, employing the atypical metasurface, may provide the wide field of view without limitation of expansion of the field of view due to a diffraction element.

According to an aspect of the disclosure, the atypical metasurface may allow uniformly high diffraction efficiencies for various incident angles, and the waveguide image combiner and the AR device, employing the atypical metasurface, may enable a virtual image to be transmitted to the eyes of the user without degrading brightness uniformity and color uniformity of the virtual image.

According to an aspect of the disclosure, an atypical metasurface, includes: a 2-dimensional plane; and a plurality of atypical unit structures which may be periodically arranged on the 2-dimensional plane, wherein each of the plurality of atypical unit structures may have an atypical pattern that is not periodic.

Each of the plurality of atypical unit structures may be configured to achieve a maximum diffractive efficiency at a target diffraction order.

The target diffraction order may be a 1st-order diffraction order.

A width of each of the plurality of atypical unit structures may be less than an operating wavelength of the atypical metasurface.

The width of each of the plurality of atypical unit structures may be more than one hundred nm for an operating wavelength of a visible light band.

Each of the plurality of atypical unit structures may include a plurality of regions divided by a grid on the 2-dimensional plane, the plurality of regions may be filled with a high-refractive index dielectric or not filled with any material.

Each region of the plurality of regions may be any one of square shaped, rectangular shaped, circular shaped, and polygonal shaped.

The plurality of regions may have a subwavelength size of 20 nm or more, or 10 nm or less.

Each of the plurality of atypical unit structures may be formed of at least one of a-Si, a-Si:H, TiO₂, and GaN.

A waveguide image combiner may include a waveguide, an input-coupling element, and an output-coupling element, wherein at least one of the input-coupling element and the output-coupling element may be the atypical metasurface, and wherein the waveguide may be configured to allow a light to be input into the input-coupling element and output the light through the output-coupling element.

An augmented reality device may include a display engine which may be configured to output a light of an image, and the waveguide image combiner, wherein the waveguide image combiner may be configured to guide the light output from the display engine to a target region being an eye motion box of a user.

The augmented reality device may further include augmented reality glasses including a left-eye element and a right-eye element corresponding to a left eye and a right eye of the user, respectively, wherein each of the left-eye element and the right-eye element may include the display engine and the waveguide image combiner.

The input-coupling element and the output-coupling element may be separately manufactured and attached to a surface of the waveguide.

The input-coupling element and the output-coupling element may be formed on a surface of the waveguide by etching or imprinting.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a plan view schematically showing an atypical metasurface according to one or more embodiments;

FIG. 2 is a plan view schematically showing an atypical unit structure of the atypical metasurface of FIG. 1 according to one or more embodiments;

FIG. 3 is a perspective view schematically showing an atypical unit structure of an atypical metasurface, according to one or more embodiments;

FIG. 4 schematically shows a method of designing an atypical metasurface according to one or more embodiments;

FIG. 5 illustrates an initial refractive index distribution of an atypical metasurface according to one or more embodiments;

FIG. 6 is a view for describing forward simulation in a calculation process for an atypical metasurface according to one or more embodiments.

FIG. 7 is a view for describing adjoint simulation in a calculation process for an atypical metasurface according to one or more embodiments;

FIG. 8 is a view for describing binarization in a unit structure of an atypical metasurface according to one or more embodiments;

FIG. 9 is a plan view schematically showing an atypical metasurface manufactured by a method of designing an atypical metasurface, according to one or more embodiments;

FIG. 10 is a graph showing a Bloch mode excited in an atypical metasurface according to one or more embodiments;

FIG. 11 shows a +1-order diffractive efficiency with respect to incident light on an atypical metasurface according to one or more embodiments;

FIG. 12 shows 0-order and +1-order diffraction efficiencies with respect to 1-dimensional incident light on an atypical metasurface according to one or more embodiments;

FIG. 13 schematically shows a waveguide image combiner according to one or more embodiments; and

FIG. 14 schematically shows augmented reality glasses according to one or more embodiments;

### DETAILED DESCRIPTION

Hereinafter, one or more embodiments of the present disclosure will be described in detail with reference to the attached drawings to allow those of ordinary skill in the art to easily carry out the embodiments of the present disclosure. However, the present disclosure may be implemented in various forms, and are not limited to the one or more embodiments of the present disclosure described herein. To clearly describe the present disclosure, parts that are not associated with the description have been omitted from the drawings, and throughout the specification, identical reference numerals refer to identical parts.

Although terms used in embodiments of the present disclosure are selected with general terms popularly used under the consideration of functions in the disclosure, the terms may vary according to the intention of those of ordinary skill in the art, judicial precedents, or introduction of new technology. In addition, in a specific case, the applicant voluntarily may select terms, and in this case, the meaning of the terms may be disclosed in a corresponding description part of one or more embodiments of the present disclosure. Thus, the terms used in herein should be defined not by the simple names of the terms but by the meaning of the terms and the contents throughout the present disclosure.

Singular forms may include plural forms unless apparently indicated otherwise contextually. When a portion is referred to as “comprising” a component, the portion may not exclude another component but may further include another component unless stated otherwise.

Hereinafter, the present disclosure will be described in detail with reference to the attached drawings.

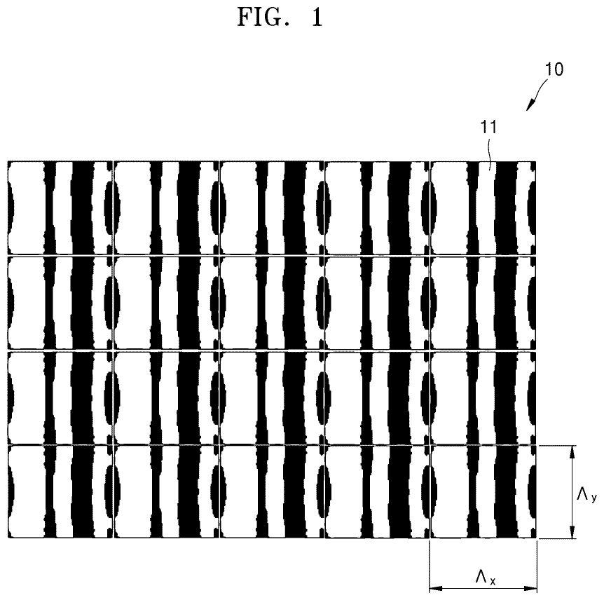

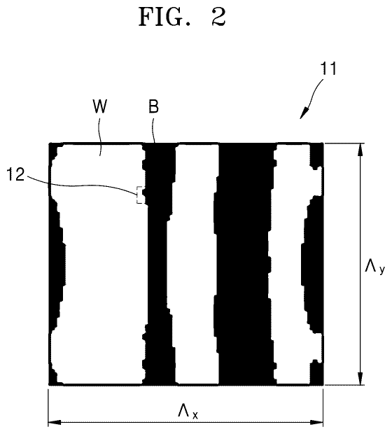

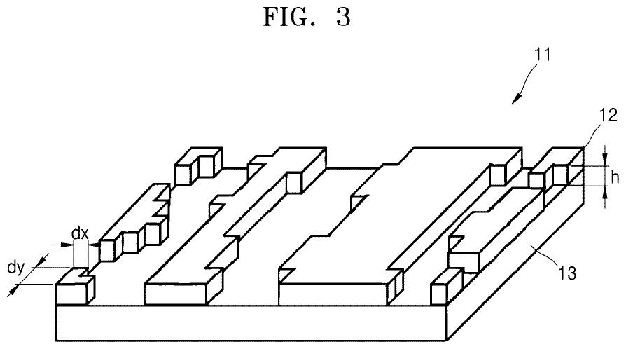

FIG. 1 is a plan view schematically showing an atypical metasurface 10 according to one or more embodiments, FIG. 2 is a plan view of an atypical unit structure 11 of the atypical metasurface 10 according to one or more embodiments, and FIG. 3 is a perspective view schematically showing the atypical unit structure of the atypical metasurface according to one or more embodiments.

Referring to FIG. 1, the atypical metasurface 10 may include a plurality of atypical unit structures 11. The plurality of atypical unit structures 11 may have the same structure and may be arranged in a periodic array on a 2-dimensional plane. The atypical unit structures 11 may be periodically arranged with a period of Λₓ in a direction x and a period of Λ_{y} in a direction y on an x-y plane. Each atypical unit structure 11 may be understood as a minimum unit regularly arranged to constitute the atypical metasurface 10. The periods of Λₓ and Λ_{y} may be understood as a width in the direction x and a width in the direction y of the atypical unit structure 11, respectively. Direction x on the x-y plane may correspond to a horizontal direction. Direction y on the x-y plane may correspond to a vertical direction.

A material constituting the atypical metasurface 10 may be a dielectric material having a high refractive index to improve complex amplitude controllability by maximizing interaction with incident light. The atypical metasurface 10 may be formed of a-Si, a-Si:H, TiO₂, GaN, however the atypical metasurface 10 is not limited thereto.

The atypical unit structure 11 may have a structure with a width Λₓ in the direction x and a width Λ_{y} in the direction y in which a high-refractive index dielectric is formed to a predetermined thickness in an atypical pattern. In FIG. 2, a black region B may be a region of the high-refractive index dielectric, and the other region W may be understood as an air region. The atypical pattern of the atypical unit structure 11 may be implemented as an atypical array of nanostructures 12 that are high-refractive index dielectrics, as described with reference to FIG. 3. That is, the atypical unit structure 11 may be manufactured by etching the high-refractive index dielectric or using imprinting, however it is not limited thereto, so as to have the atypical pattern in which a surface of the atypical unit structure 11 is divided by a grid having a predetermined grid spacing and each divided region is filled with a high-refractive index dielectric or remains as an empty space. In FIG. 2, a region B of a high-refractive index dielectric (i.e., a black region) may be implemented with a group of the nanostructures 12, and the other region W may be understood as a region not filled with the nanostructures 12. A conventional metasurface may be understood as a typical metasurface because nanostructures such as nanorods are implemented as a periodic array or by a subwavelength-size grid. On the other hand, the atypical unit structure 11 of the atypical metasurface 10 may be implemented as an atypical array or atypical pattern of the nanostructures 12.

The atypical pattern of the atypical unit structure 11 may be designed to achieve a maximum diffractive efficiency at a target diffraction order. The target diffraction order may be a 1st-order diffraction order, however it is not limited thereto. The atypical pattern may not be a pattern of arrangement in either a fixed period or a regularly increasing or decreasing period. That is, the atypical pattern of the atypical unit structure 11 may not have a periodic pattern. In addition, the atypical pattern may also be different from a pattern constituting a hologram or a graphic interference pattern of a holographic optical element.

The atypical pattern of the atypical unit structure 11 may be configured such that a Bloch mode excited in the atypical unit structure 11 may contribute the most to the target diffraction order, as described below.

The width Λₓ in the direction x and the width Λ_{y} in the direction y, of the atypical unit structure 11, each may have a value (i.e., a subwavelength) less than an operating wavelength (an operating wavelength of the metasurface) of incident light or a value around the operating wavelength. According to one or more embodiments, the widths Λₓ and Λ_{y} of the atypical unit structure 11 may have several hundred (i.e. more than one hundred) of nm in a visible-light band. The width Λₓ in the direction x and the width Λ_{y} in the direction y, of the atypical unit structure 11, may be different from or the same as each other.

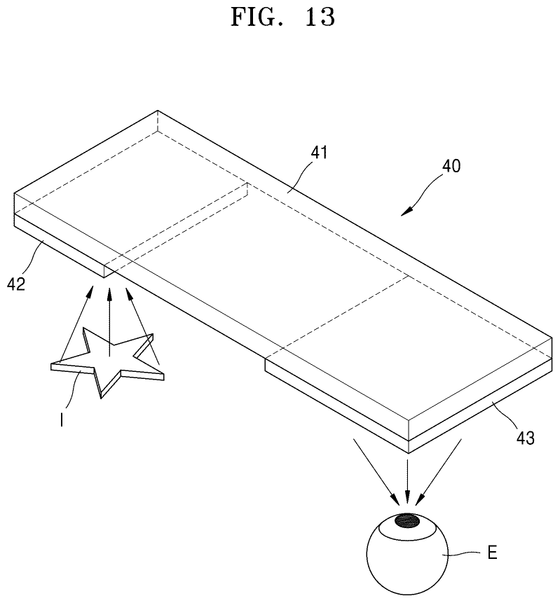

As will be described below, the atypical metasurface 10 may operate as at least one of an input-coupling element, a folding element, an expanding element, and an output-coupling element for a transparent substrate (a waveguide) 41 of FIG. 13.

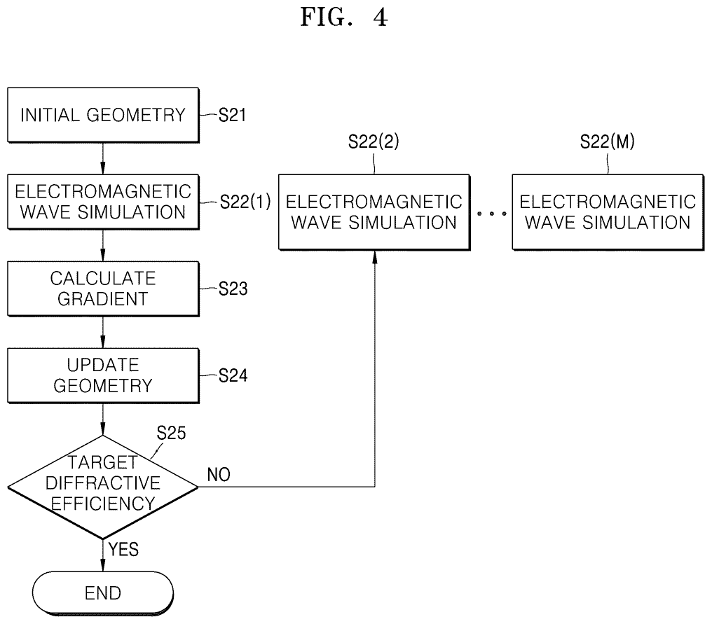

Next, referring to FIGS. 4 through 12, a method of designing the atypical pattern of the atypical metasurface 10 will be described in detail with reference.

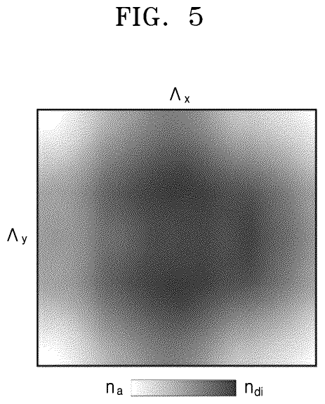

FIG. 4 schematically shows a method of designing an atypical metasurface according to one or more embodiments, and FIG. 5 illustrates an initial refractive index distribution of an atypical metasurface according to one or more embodiments.

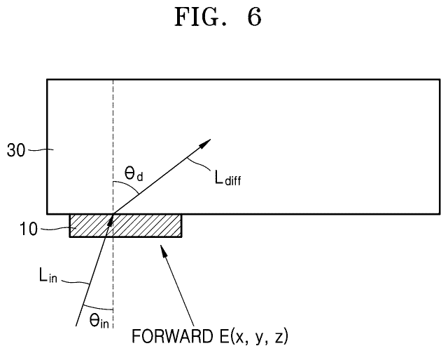

Referring to FIGS. 4 and 5, first, the unit structure of the atypical metasurface having the widths Λₓ and Λ_{y} is considered. The atypical metasurface may be formed by repeatedly arranging the unit structure of the atypical metasurface having the widths Λₓ and Λ_{y}. The widths Λₓ and Λ_{y} of the unit structure of the atypical metasurface may be determined as below, according to one or more embodiments. A waveguide angle of light in a waveguide 30 of FIG. 6 may be determined by an incident angle θᵢₙ of light incident to a coupling element (i.e., the atypical metasurface 10) and a period of the atypical metasurface 10, based on Equation 1.

$${n}_{g} sin {θ}_{out} - {n}_{a} sin {θ}_{in} = m \frac{λ}{Λ} \qquad [ Equation 1 ]$$

λ indicates a target operating wavelength of the atypical metasurface 10 to be designed, n_{g} indicates a refractive index of the waveguide 30, nₐ indicates a refractive index of air, and m indicates a target diffraction order. According to one or more embodiments, for λ=660 nm, n_{g}=1.7 (glass plate), and nₐ=1, it is set such that Λ_{y}=λ/n_{g}=375 nm to prevent diffraction in a Y-axis direction, and Λₓ may be calculated using Equation 1 and may be set like Λₓ=500 nm when a period is designed such that an angle of the +1-order light is 51º in an X-axis direction with respect to an incident angle of 0° for a wide field of view (FoV).

Referring to FIGS. 4 and 5, a refractive index distribution that satisfies nₐ≤ n≤ n_{di} as an initial geometry Do satisfied by the unit structure of the atypical metasurface may be set in operation S21. nₐ indicates a refractive index of air, and n_{di} indicates a refractive index of a dielectric constituting a metasurface. Since a physical coefficient meaningful in the metasurface may be a dielectric distribution, and the dielectric distribution may be regarded as a refractive index distribution, a geometry of the metasurface may be defined from the refractive index distribution.

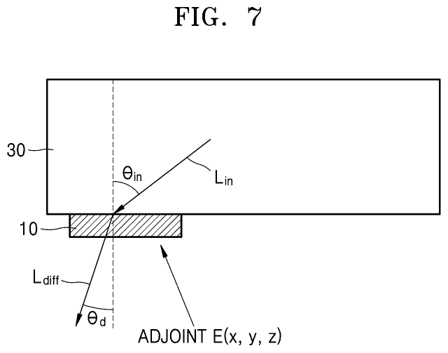

Next, a diffractive efficiency at the target diffraction order may be calculated for the metasurface having an initial refractive index distribution Do by using electromagnetic wave simulation in operation S22(1). The target diffraction order may be, according to one or more embodiments, the 1st-order diffraction order. FIG. 6 is a view for describing forward simulation in a calculation process for an atypical metasurface, and FIG. 7 is a view for describing adjoint simulation in a calculation process for an atypical metasurface. As shown in FIG. 6, m different incident lights Lᵢₙ may be diffracted from the metasurface 10 having the refractive index of Do for an incident angle θᵢ of m different incident lights Lᵢₙ, and diffracted light L_{diff} may be incident to the waveguide 30, such that an electric field distribution E(x, y, z) in the waveguide 30 may be calculated using forward simulation. Likewise, as shown in FIG. 7, the light Lᵢₙ incident to the metasurface 10 in the waveguide 30 may be diffracted from the metasurface 10, and the diffracted light L_{diff} may go out of the waveguide 30, such that the electric field distribution in the waveguide 30 may be calculated using adjoint simulation. By using such forward simulation and adjoint simulation, the diffractive efficiency at the target diffraction order of the metasurface may be calculated. The incident light Lᵢₙ may be incident to a 3-dimensional (3D) space, such that the incident angle θᵢ of the incident light Lᵢₙ may be given as a function of an azimuthal angle and a polar angle. This process may also be called electromagnetic wave simulation.

Next, a refractive index gradient value G(x, y, z) indicating a diffractive efficiency change at the target diffraction order with respect to a refractive index change at each position of the metasurface may be calculated, in operation S23. The refractive index gradient value G(x, y, z) may be calculated using Equation 2.

$$G ( x , y , z ) = \frac{δ FoM}{δ ε} \qquad [ Equation 2 ]$$

FoM indicates the diffractive efficiency of the target diffraction order, and ε indicates a refractive index.

The refractive index gradient value may be calculated as in Equation 3 by using calculation values of forward simulation E and adjoint simulation E^{A}.

$$\frac{δ F o M}{δ ε} ∝ Re [ E \cdot {E}^{A} ] \qquad [ Equation 3 ]$$

To make a metasurface element operating at a wide FoV, a weighted average of refractive index gradient values with respect to M incident angles θᵢ may be calculated using Equation 4 provided below.

$${{\sum }^{M}}_{i = 1} {a}_{i} \times Re [ E ( {θ}_{i} ) \cdot {E}^{A} ( {θ}_{i} ) ] \qquad [ Equation 4 ]$$

M indicates an integer of 2 or greater, and a; indicates a weighted constant that satisfies Σᵢ₌₁^{M}aᵢ=1. The weighted constant may have an influence upon the diffractive efficiency at the target diffraction order of the metasurface through optimization. That is, through proper weight value distribution, the diffractive efficiency of the metasurface may be equalized depending on an incident angle. Each weight constant may be determined based on the diffractive efficiency of the target diffraction order of the metasurface according to the incident angle θᵢ. According to one or more embodiments, by increasing a weight constant for an incident angle having a low diffractive efficiency, the diffractive efficiency of the final metasurface may be equalized. In other words, due to interference between excited Bloch modes, a uniformly high diffractive efficiency may be generated at the target diffraction order for incident lights having different incident angles.

Next, by multiplying an appropriate learning rate constant q to the calculated refractive index gradient value G of the metasurface as in Equation 5, the geometry of the metasurface (i.e., the refractive index distribution D₀) may be updated in operation S24.

$${D}_{0} \to {D}_{0} + q G \qquad [ Equation 5 ]$$

Updating of the geometry may include binarization of making a refractive index distribution of nₐ<n<n_{di} into nₐ or n_{di} such that the final structure of the metasurface includes air and a dielectric. According to one or more embodiments, updating of the geometry may further include a filtering operation such as a Gaussian filter, etc., for manufacturability and robustness of the metasurface.

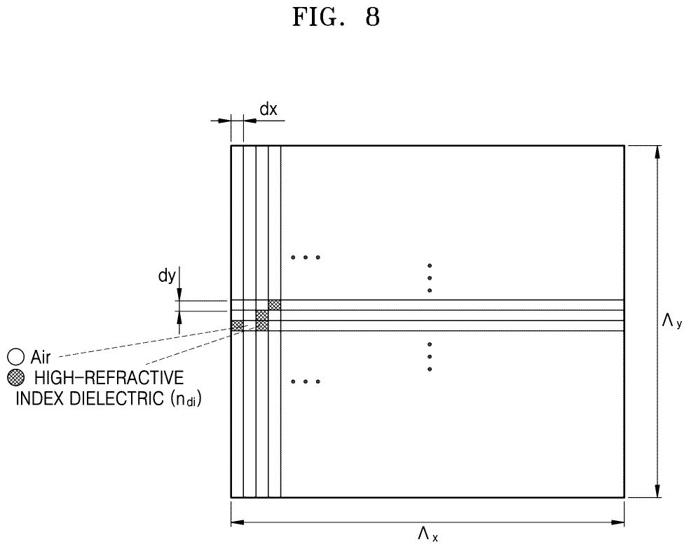

FIG. 8 is a view for describing binarization in a unit structure of an atypical metasurface according to one or more embodiments. Referring to FIG. 8, a unit structure having the widths Λₓ and Λ_{y} of the metasurface may be divided by a grid having widths dx and dy, and each region divided by the grid may be filled with a high-refractive index dielectric or may be emptied (i.e. not filled with any material). According to one or more embodiments, the widths Λₓ and Λ_{y} may be several hundreds of nm, and the widths dx and dy may have a subwavelength size of about several tens of nm (i.e. 20 or more nm) or 10 nms or less. The horizontal width dx and the vertical width dy may be the same as or different from each other. Shapes of the regions divided by the grid may be, but not limited to, square, rectangular, circular, polygonal, etc. . . .

Referring back to FIG. 3, a unit structure of a binarized metasurface may be understood as a set of the nanostructures 12. Each nanostructure 12 may be, but not limited to, a pillar having widths dx and dy and a height h. The height h of each nanostructure 12 may be less than an operating wavelength of incident light. More specifically, the height h of each nanostructure 12 may be about λ/n_{di}. λ indicates an operating wavelength of incident light, and n_{di} indicates a refractive index of the atypical unit structure 11. According to one or more embodiments, the height h of the nanostructure 12 may have a thickness of several tens of nm to several hundreds of nm in a visible light band. The widths dx and dy of each nanostructure 12 may have a size of about several tens of nm or 10 nm or less. The horizontal width dx and the vertical width dy of each nanostructure 12 may be the same as or different from each other. Each nanostructure 12 may be, but not limited to, a square pillar, a rectangular pillar, a circular pillar, a polygonal pillar, etc.

Operations S22 through S24 may be repeated until a diffractive efficiency at the target diffraction order of the updated metasurface converges, in operation S25. That is, the light diffracted from the metasurface may be calculated by forward simulation and adjoint simulation based on the updated geometry (i.e., the refractive index distribution) of the metasurface, and the diffractive efficiency at the target diffraction order of the metasurface may be calculated using the diffracted light in operation S22(2), and the refractive index gradient value may be calculated in operation S23, based on which the geometry (i.e., the refractive index distribution) of the metasurface may be updated again. Binarization in updating of the geometry may not be performed every time during repetition of operations S22 through S24.

Since the geometry of the metasurface updated in the above-described manner may have the binarized refractive index distribution, the metasurface may be manufactured by etching high-refractive index dielectric or using imprinting, etc. Etching or imprinting may use a known manufacturing method, and thus will not be described.

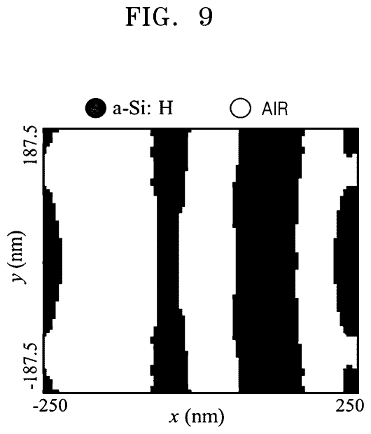

FIG. 9 is a plan view schematically showing an atypical metasurface manufactured by a method of designing an atypical metasurface according to one or more embodiments. Finally, when the diffractive efficiency at the target diffraction order converges, the unit structure of the atypical metasurface may have a dielectric formed in an atypical pattern as shown in FIG. 9. The pattern of the unit structure of the final atypical metasurface may be calculated variously according to the initial refractive index distribution.

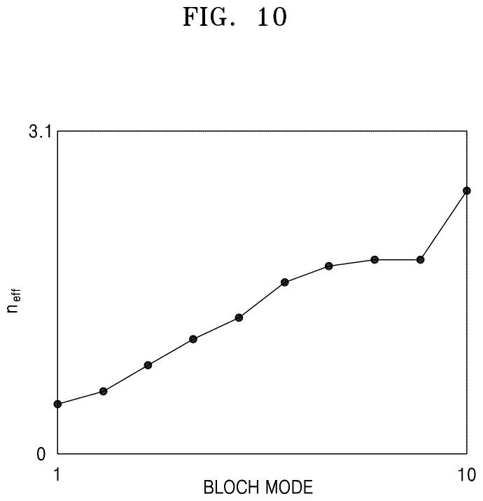

FIG. 10 is a graph showing a Bloch mode excited in an atypical metasurface according to one or more embodiments. Referring to FIG. 10, it may be seen that by calculating the Bloch mode excited in the unit structure of the atypical metasurface according to one or more embodiments, 10 different modes having an effective refractive index of 0 to 3.1 are formed. A uniformly high +1-order diffractive efficiency (the target diffraction order) may be generated for incident lights having different incident angles due to interference between the excited Bloch modes. The effective refractive index of the Bloch mode may differ according to the permittivity of the dielectric of the atypical metasurface or the initial refractive index distribution, etc., and about 5 or more Bloch modes may be excited on the atypical metasurface according to one or more embodiments. On the other hand, the number of Bloch modes of a conventional diffractive optical element (DOE), holographic optical element (HOE), or typical metasurface element may be about 3. Herein, the typical metasurface may mean a metasurface formed in a regular pattern.

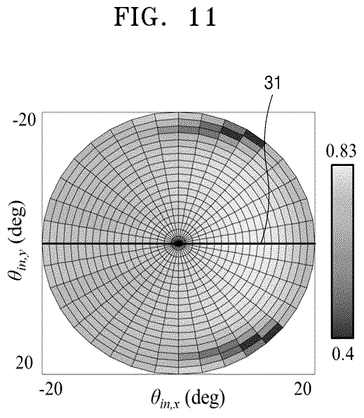

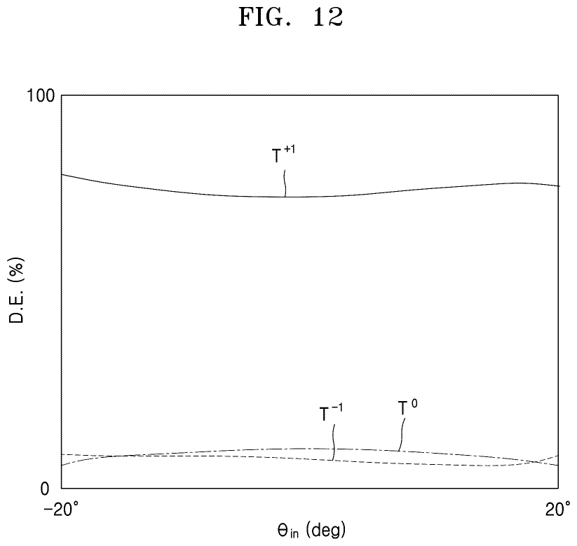

FIG. 11 shows a +1-order diffractive efficiency with respect to incident light on an atypical metasurface according to one or more embodiments, and FIG. 12 shows 0-order and +1-order diffraction efficiencies with respect to 1-dimensional incident light on an atypical metasurface according to one or more embodiments.

It may be seen that by calculating the diffractive efficiency of the +1-order diffraction order for the incident angle, a high diffractive efficiency of 0.8 or greater on average for a wide incident angle appears uniformly, as shown in FIG. 11. Such a diffractive efficiency is 2 to 32 times higher than that of the conventional DOE/HOE or typical metasurface, such that a waveguide image combiner employing an atypical metasurface according to one or more embodiments may enable a bright virtual image to be transmitted with low power consumption.

FIG. 12 is a graph showing a diffractive efficiency for 1D incident angle corresponding to a bold line 31 of FIG. 11, in which for all incident angles, a diffractive efficiency T⁺¹ for a +1-order diffracted light maintains a uniformly high value, whereas diffraction efficiencies T⁰ and T⁻¹ for 0-order and −1-order diffracted light operating as losses are suppressed to be low.

FIG. 13 schematically shows a waveguide image combiner according to one or more embodiments.

Referring to FIG. 13, a waveguide image combiner 40 according to one or more embodiments may include a waveguide 41, an input-coupling element 42, and an output-coupling element 43.

The waveguide 41 may be a plate-shape member including a surface and the other surface opposing the surface. The waveguide 41 is shown like a flat plate-shape member, but may be a plate-shape member having a curved surface. The waveguide 41 may be formed of a material that is transparent in a wavelength band of light where the waveguide metasurface operates. According to one or more embodiments, the waveguide 41 may be formed of, but not limited to, glass or a polymer material having a transmissivity of 90% or greater in the visible light band.

At least one of the input-coupling element 42 and the output-coupling element 43 may include the atypical metasurface 20 according to one or more embodiments. The atypical metasurface 10 may be separately manufactured and attached to the waveguide 41, without being limited thereto. The atypical metasurface 10 may be directly formed (e.g., etched or imprinted) on the surface of the waveguide 41.

While it is shown in FIG. 13 that the input-coupling element 42 and the output-coupling element 43 are provided at an incident plane side of the waveguide 41, the input-coupling element 42 and the output-coupling element 43 may be provided at an exit surface side of the waveguide 41, on both surfaces of the waveguide 41, or inside the waveguide 41.

In the waveguide 41, at least one of a folding element for changing a direction of input light toward the output-coupling element 43 and an expansion element for pupil expansion may be further provided. The folding element and the expansion element may be located between the input-coupling element 42 and the output-coupling element 43, and may be arranged to overlap the output-coupling element 43 in some regions, or may be arranged to overlap the output-coupling element 43 in the same region. The folding element and the expansion element may also be the atypical metasurface 10 according to one or more embodiments.

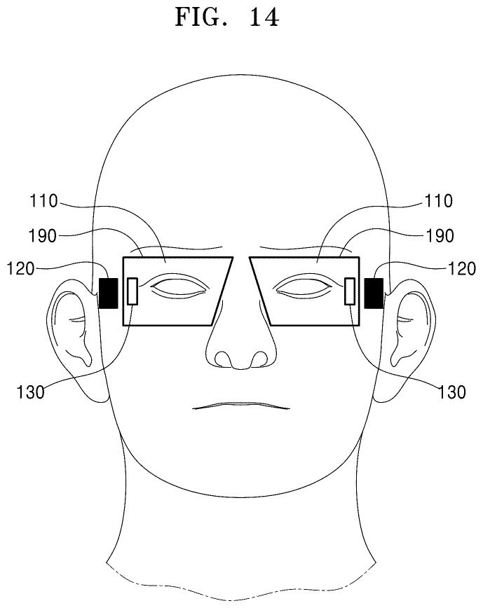

Light of a virtual image I projected from a display engine 120 of FIG. 14 may be input to the waveguide 41 through the input-coupling element 42 and propagate by total reflection inside the waveguide 41. The light of the virtual image I propagating inside the waveguide 41 may be output to a target region through the output-coupling element 43. The target region may be an eye motion box (EMB) of a user. That is, the waveguide image combiner 40 may receive the light of the virtual image I and pass the light to the pupil of the eye E of the user.

Meanwhile, as the waveguide 41 is formed of a material transparent to the visible light band, the light may pass through the waveguide 41 in a thickness direction of the waveguide 41. Thus, the user may see a real scene outside the waveguide 41 through the waveguide 41. According to one or more embodiments, an optical element blocking light transmission based on an electrical signal may be provided in the waveguide 41.

FIG. 14 schematically shows an augmented reality (AR) device according to one or more embodiments. Referring to FIG. 14, the AR device may be AR glasses.

The AR device may use the waveguide image combiner described with reference to FIG. 13 as a left-eye element and a right-eye element. Each waveguide image combiner 110 may be fixed to a frame 190.

The AR device may further include the display engine 120. The display engine 120 may be positioned near the temple of the head of the user and fixed to the frame 190. The display engine 120 may be, but no limited to, a subminiature projector using a 2D image panel or a subminiature projector of a scanning type. Information processing and image formation for the display engine 120 may be directly performed on a computer of the AR device, or may be performed on an external electronic device such as a smart phone, a tablet, a computer, a laptop computer, other intelligent (smart) devices of any type, etc., connected to the AR device. Signal transmission between the AR device and the external electronic device may be performed through wired communication and/or wireless communication. The AR device may be supplied with power of at least any one of an embedded power source (a chargeable battery), an external device, or an external power source.

The input-coupling element 42 of FIG. 13 of the waveguide image combiner 110 may be located on a surface opposing the display engine 120 of the waveguide 41 of FIG. 13 or the other surface, and input light output from the display engine 120 to the waveguide 41. The waveguide 41 may guide the input light toward the output-coupling element 43 of FIG. 13, and the waveguide image combiner 110 may output the light to a target region through the output-coupling element 43 of FIG. 13. In this case, the target region may be an eye motion box of the user.

Although it is shown in FIG. 14 that the waveguide image combiner 110 and the display engine 120 are provided at a left side and a right side, respectively, the present disclosure is not limited thereto. According to one or more embodiments, the image combiner 110 and the display engine 120 may be provided at any one of the left side and the right side. According to one or more embodiments, the image combiner 110 may be provided across the left side and the right side, and the display engine 120 may be provided commonly for the left side and the right side or provided to correspond to the left side and the right side, respectively.

In the present disclosure, an example of the waveguide image combiner 110 applied to AR glasses has been described, but it would be apparently understood by those of ordinary skill in the art that the waveguide image combiner 110 is applicable to a near-eye display and a head-up display (HUD) device capable of expressing virtual reality.

In the present disclosure, an ‘AR device’ may refer to a device capable of expressing AR, and may include not only AR glasses in the form of glasses worn on a facial part of the user, but also a head-mounted display (HMD) or an AR helmet worn on a head part of the user, the HUD, etc.

As described above, the atypical metasurface may increase the diffractive efficiency of a specific order, such that the waveguide image combiner 40 of FIG. 13 employing the atypical metasurface may transmit a bright virtual image at low power, and thus, the size and thickness of the waveguide image combiner may be reduced, whereby the AR device may improve the brightness of an image to be displayed and may have a compact size, and power consumption required for the display engine may be reduced.

Moreover, the atypical metasurface may have a high diffractive efficiency at a wide viewing angle, such that the waveguide image combiner and the AR device, employing the atypical metasurface, may provide the wide FOV without limitation of expansion of the FoV due to a diffraction element.

The atypical metasurface may allow uniformly high diffraction efficiencies for various incident angles, and the waveguide image combiner and the AR device, employing the atypical metasurface, may enable a virtual image to be transmitted to the eyes of the user without degrading brightness uniformity and color uniformity of the virtual image.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. An atypical metasurface, comprising:
a 2-dimensional plane; and
a plurality of atypical unit structures periodically arranged on the 2-dimensional plane,
wherein each of the plurality of atypical unit structures has an atypical pattern that is not periodic.

2. The atypical metasurface of claim 1, wherein each of the plurality of atypical unit structures is configured to achieve a maximum diffractive efficiency at a target diffraction order.

3. The atypical metasurface of claim 2, wherein the target diffraction order is a 1 st-order diffraction order.

4. The atypical metasurface of claim 1, wherein a width of each of the plurality of atypical unit structures is less than an operating wavelength of the atypical metasurface.

5. The atypical metasurface of claim 4, wherein the width of each of the plurality of atypical unit structures is more than one hundred nm for an operating wavelength of a visible light band.

6. The atypical metasurface of claim 1, wherein each of the plurality of atypical unit structures comprises a plurality of regions divided by a grid on the 2-dimensional plane, the plurality of regions being filled with a high-refractive index dielectric or not filled with any material.

7. The atypical metasurface of claim 6, wherein each region of the plurality of regions is any one of square shaped, rectangular shaped, circular shaped, and polygonal shaped.

8. The atypical metasurface of claim 6, wherein the plurality of regions have a subwavelength size of 20 nm or more, or 10 nm or less.

9. The atypical metasurface of claim 1, wherein each of the plurality of atypical unit structures is formed of at least one of a-Si, a-Si:H, TiO₂, and GaN.

10. A waveguide image combiner comprising:
a waveguide;
an input-coupling element; and
an output-coupling element,
wherein at least one of the input-coupling element and the output-coupling element is the atypical metasurface according to claim 1, and
wherein the waveguide is configured to allow a light to be input into the input-coupling element and output the light through the output-coupling element.

11. An augmented reality device comprising:
a display engine configured to output a light of an image; and
the waveguide image combiner according to claim 10,
wherein the waveguide image combiner is configured to guide the light output from the display engine to a target region being an eye motion box of a user.

12. The augmented reality device of claim 11, further comprising augmented reality glasses comprising a left-eye element and a right-eye element corresponding to a left eye and a right eye of the user, respectively,
wherein each of the left-eye element and the right-eye element comprises the display engine and the waveguide image combiner.

13. The waveguide image combiner of claim 10, wherein the input-coupling element and the output-coupling element are separately manufactured and attached to a surface of the waveguide.

14. The waveguide image combiner of claim 10, wherein the input-coupling element and the output-coupling element are formed on a surface of the waveguide by etching or imprinting.
